(19) United States
(12) Patent Application Publication
(10) Pub. No.: US 2008/0046825 A1
(43) Pub. Date: Feb. 21, 2008

(54) Method, Apparatus or Software for Providing a Portal Comprising One or More Portlets for Displaying Data

(75) Inventors: Bharat Veer Bedi, Portsmouth (GB); Andrew James Frederick Bravery, Wiltshire (GB); David C. Conway-Jones, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/749,196

(22) Filed: May 16, 2007

(30) Foreign Application Priority Data
Jun. 9, 2006 (GB) 0611399.7

(51) Int. Cl. G06F 3/00

(52) U.S. Cl. 715/742

(57) ABSTRACT

A method, apparatus and software is disclosed for providing a portal. The portal, running on a client device, comprises one or more portlets for displaying data. The portal and portlets can be dynamically configured depending on the data sources being displayed.

### FIELD OF INVENTION

The present invention relates to a method, apparatus or software for providing a portal comprising one or more portlets for displaying data.

### BACKGROUND OF THE INVENTION

A portal presents content or data from various data sources as a portal page, typically accessed via a client device as a web page. The portal is typically provided by a portal application program running on a portal server, which is arranged to aggregate data from a group of sources. In this way, the portal server, via the portal, is a logical gateway for a set of one or more application programs or other data sources. A portal page can include one or more portlets, which are web page components arranged to process and generate individual dynamic data content or to present static content.

The portal may provide features enabling a user to customize the portal content or appearance. Since a portal can be customized, the content of each portlet in a portal may vary each time the portal is accessed, in accordance with a particular customization. Within a given customization, a portal is normally statically bound to the relevant set of data sources. In other words, the portal comprises a predefined set of portlets. Changing a customization to add or remove portlets requires intervention by either a user or an administrator to modify the portal content and format. Each time a portal is accessed, the portal server application is arranged to aggregate a set of portlets to form mark-up or source for a portal page, which is then sent to the portal client application for display.

Portal data may, in time, become out of date, thus prompting the refresh of the portal page either manually or automatically. Where data changes rapidly, such refreshes are correspondingly more frequent thus increasing the processing carried out by the portal server to produce each refreshed portal page and an increase in network traffic.

### SUMMARY OF THE INVENTION

A portal manager manages a portal on a client device, the portal comprising one or more portlets for displaying data on the client device. A set of one or more data sources that are of interest to a user of the client device is identified. Each data source within the identified set is assigned to a respective portlet. In response to detecting a modification to the set of one or more data sources, one or more respective portlets is added or removed.

The invention provides client-side dynamic provisioning of portlets when new data sources are added. The invention also allows for deletion of portlets for data sources that are no longer required by the user of the client device.

### BRIEF DESCRIPTION OF THE DRAWINGS

Embodiments of the invention will now be described, by way of example only, with reference to the accompanying drawings in which:

FIG. 1 is a schematic illustration of a data processing system, comprising client and server devices;

FIG. 2 is a table illustrating functional elements of a client and server device of FIG. 1;

FIGS. 3a and 3b are schematic illustrations of data being displayed in a portal provided by the elements of FIG. 2;

FIG. 4 is a flow chart illustrating processing carried out by the client device of FIG. 2;

FIGS. 5a and 5b are schematic illustrations of data being displayed in a portal provided by the elements of FIG. 2;

FIGS. 6a and 6b are flow charts illustrating processing carried out by the server device and client device of FIG. 2.

### DETAILED DESCRIPTION

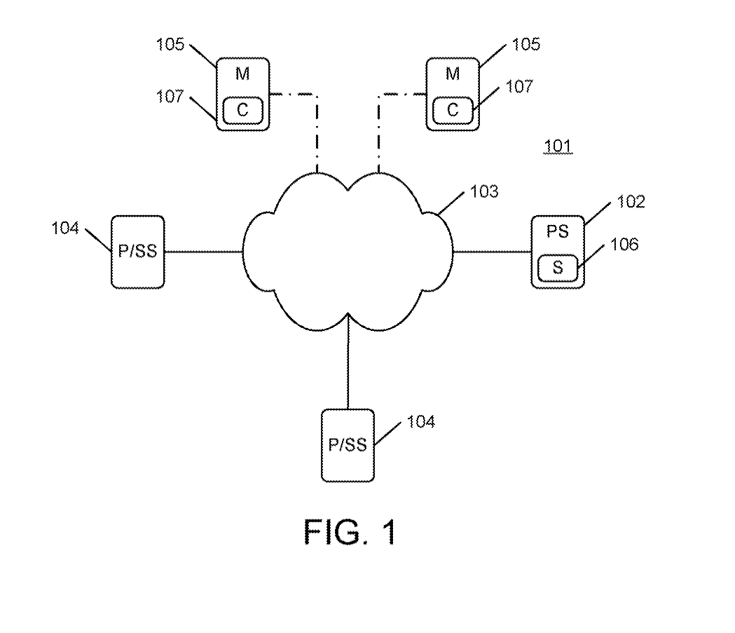

With reference to FIG. 1, a data processing system 101 comprises a first server computer (PS) 102 connected via a network 103, in the form of the Internet, to a set of second servers (P/SS) 104. The network 103 also provides wireless links to a set of mobile devices (M) 105. The second servers 104 provide data sources that operate on a publish/subscribe basis. In other words, in order to gain access to the data provided by the data source, a user can register with or subscribe to the data source. From then on, data published by the data source will be delivered to the subscribing user. The first server 102 runs a portal application server application program (S) 106 that provides a portal service. The portal server application program 106 is arranged to pass the data from the second servers 104 to the mobile devices 105 for display to a user. The mobile devices 105 run portal client application programs (C) 107 arranged to render a portal page for displaying the data.

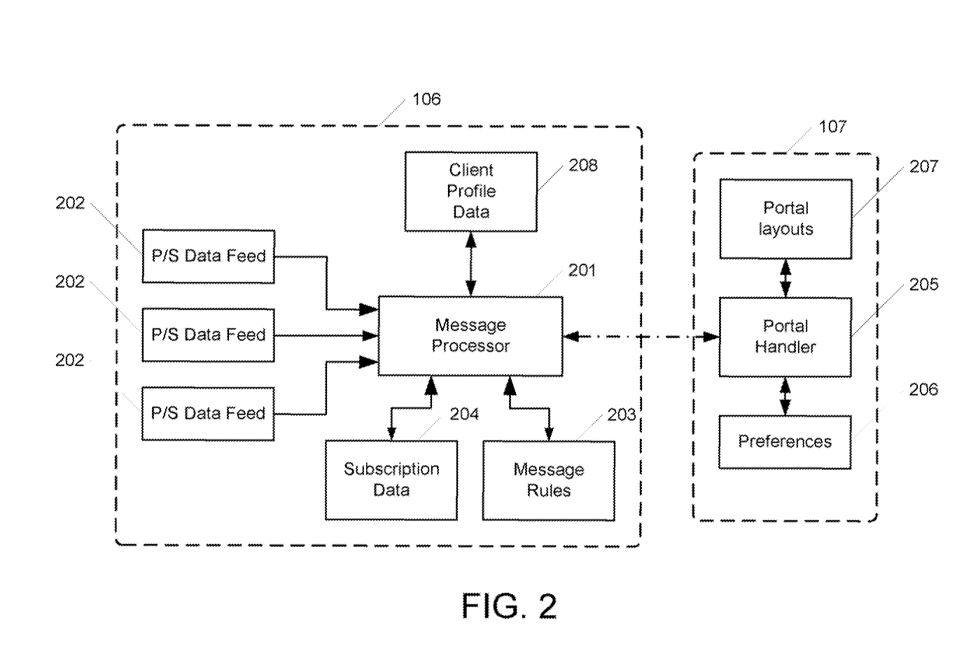

FIG. 2 shows the elements of the portal server and client application programs 106, 107 in further detail. The portal server application program 106 comprises a central message processor 201 which takes input messages from a set of publish/subscribe data, feeds 202 supplied by second servers (not shown). The message processor 201 is arranged to convert the input data feeds 202 into a message format (described below) for transmission to client application programs 107. The message processor 201 uses a set of message rules 203 which define translations between the messages from the data feeds 202 and a message format for transmission to the client application programs 107. The message processor 201 also holds subscription data 204, which provides a record of the subscriptions for each portal client application program 107. The subscription data 204 is used by the message processor 201 in order to forward messages from given data feeds 202 to the appropriate portal client application program 107. In the present embodiment, the message processor is implemented using a message broker software system in the form of the WebSphere™ Message Broker system from IBM™ Corporation.

Messages from the message processor 201 are received in the portal client application program 107 by a portal manager 205, which is arranged to manage the presentation and maintenance of portals on the client device 105. The portal manager 205 uses preference data 206, portal layouts 207 and profile data 208 to determine the layout of the portal and how the data from the data feeds 202 should be displayed within it. The preference data 206, portal layouts 207 and profile data 208 are described in further detail below. In the present embodiment, the portal client application programs 107 is implemented in Java™ as a thin client for use in small or mobile client devices. The transmission of messages between the server and client application programs 106, 107 is preferably carried out via a GPRS (General Packet Radio Service) link using the MQ Telemetry Transport (MQTT) messaging technology from IBM™.

In the present embodiment, the portal handler 205 is arranged to also store subscription data as profile data 208. This effectively duplicates the subscription data 204 held by the message processor 201, but the version stored as the profile data 208 enables a user or administrator to gain easier access. The portal client application program manages the profile data 208 in parallel with management, of the subscription data 204 by the message processor 201. The profile data 208 comprises an entry for each instance of the portal client application program 107, which equates to an individual user. Each entry is headed by a user identifier (userid) and comprises an ordered comma-delineated list of subscriptions for a given user as follows:
userid: message account[username,password], subscription 1, subscription 2, . . . , subscription n;

In the present embodiment, subscriptions can be one of two types. The first type is a subscription to one-to-one messages such as email messages, which are published by a data source 104, such as an email server, to the portal server 102. The publication of these messages is performed securely using a username and password for each identified message account in the list.

The second type is a subscription to an information channel. The information channels comprise data published on predefined subjects which may be periodically updated and are identified in the list by a subscription name. In the present embodiment, when a user registers a client device 105 for use with the portal server 102, an appropriate entry in the profile data 208 is entered either by a portal server administrator or by the user. The profile data 208 may be modified subsequently by the user or administrator as described below.

On receipt of data from the data feed 202, the message processor 201 is arranged to identify the destination for the data from the subscription data 204 and, using the message rules 203, convert the data into an XML (Extensible Mark-up Language) message format for transmission to the appropriate client device 102. The message rules use XML tags to define the following elements of messages:
Msg—this marks the start and end of a given message.
Attribute—this identifies a characteristic of the message such as either message account name, a channel name or a user id. A channel name may be determined from the names of topics that are subscribed to.
From—this identifies the source of the data and is optional.
Subject—this identifies the subject of the data and is optional.
Body—this holds the message data.

As noted above, the portal layouts 207 define the layout of any portal displayed on the client device 105. A portal may comprise a number of portlets, each arranged to display data from an associated subscribed data source 202. The number and layout of the portal and portlets displayed on a given client device is determined dynamically by the portal, handler 205 in dependence on the subscriptions associated with the device. When a client device 105 starts up an instance of the portal client application program 107, it accesses the current set of subscriptions stored in the profile data 208. The portal handler 205 is then arranged to select a portal layout 207 depending on the subscription list and to map each subscription to an appropriate portlet within the portal. The mappings between subscriptions and portlets are stored in the preferences 206.

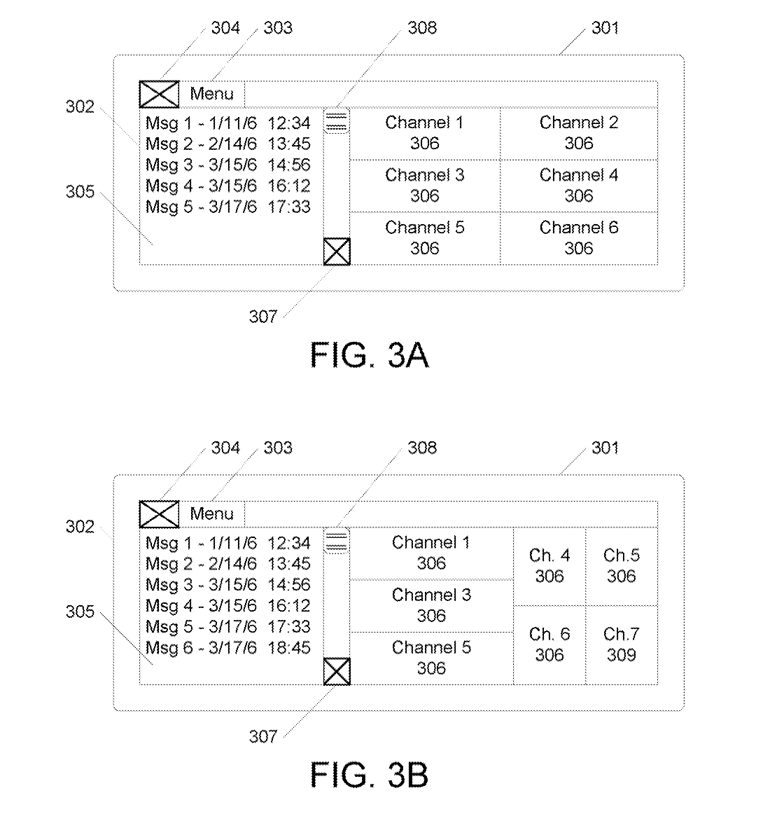

By way of example, with reference to FIG. 3A, a display 301 of the device 105 displays a portal page 302. The portal page 302 comprises a menu button 303 and a navigation button 304. The portal also comprises a first portlet 305 arranged to display a list of messages and a set of six more portlets 306, each arranged to display data, from an information channel. The first portlet 305 has a navigation button 307 and slider 308 for navigating the list of messages it displays. The portal format has been selected and displayed by the portal handler 205 in response to subscription list stored in the profile data 208. The channel names are determined by the names of the associated topics subscribed to. In the present example, the subscription list is as follows:
userid: message account name 1, channel name 1, channel name 2, channel name 3, channel name 4, channel name 5, channel name 6.

In response to this subscription list, the portal handler 205 makes the following associations, between portlets and subscriptions, in the preferences 206:
Message account name 1, portlet 1, channel name 1: portlet 2, channel name 2: portlet 3, channel name 3: portlet 4: channel name 4: portlet 5, channel name 5: portlet 6, channel name 6: portlet 7

The user can use a pointing device (not shown) to select one of the portlets 306 or a message within the first portlet 305. Once selected, the user can select a “show” command from the menu 303 to display the detailed data from the portlet as a full page, that is, the body of the data for the message or information channel. The menu 303, in the present embodiment, may provide the following five options:
Home—this option returns the display from displaying the body of data for a particular portlet to show all of the current portlets.
Show—this option displays the body of data for a particular portlet as a full page.
Add—this option enables a user to add a subscription to the portal.
Delete—this option enables a user to remove a subscription from the portal.
Exit—this option exits the portal client application program.

When the user selects the Add option from the menu 303, that user is prompted to enter the name of a channel available from the portal to which the user wishes to subscribe in response to this, the portal handler 205 sends an MQTT subscribe message to the message processor 201 that includes the client identifier (clientid) and the appropriate channel to subscribe to (channel name 7). In response to this message, the message processor 201 amends the subscriptions data 204 accordingly. In addition, the portal handler makes the appropriate addition to the subscription list help in the profile data 208. The portal handler 205 then reformats the portal by selecting a suitable portal format, from the portal layouts 207, to include the new channel and updates the preferences to include the association for the new channel and its assigned portlet. FIG. 3B shows the new portal format in which the layout of the second portlets 306 within the portal 302 have been modified to accommodate a new portlet 309 for displaying the data for the new channel (channel name 7).

Similarly, if the user selects the Delete option from the menu 303, the portal handler 205 prompts the user to enter a channel name and then, assuming the user entered “channel name 7”, sends an MQTT unsubscribe message. In response to this message the message processor 201 cancels the user's subscription by amending the user's subscription data 204. The portal handler 205 also revises the profile data 208 accordingly. The portal handler then reformats the portal and return it to the arrangement shown in FIG. 3a.

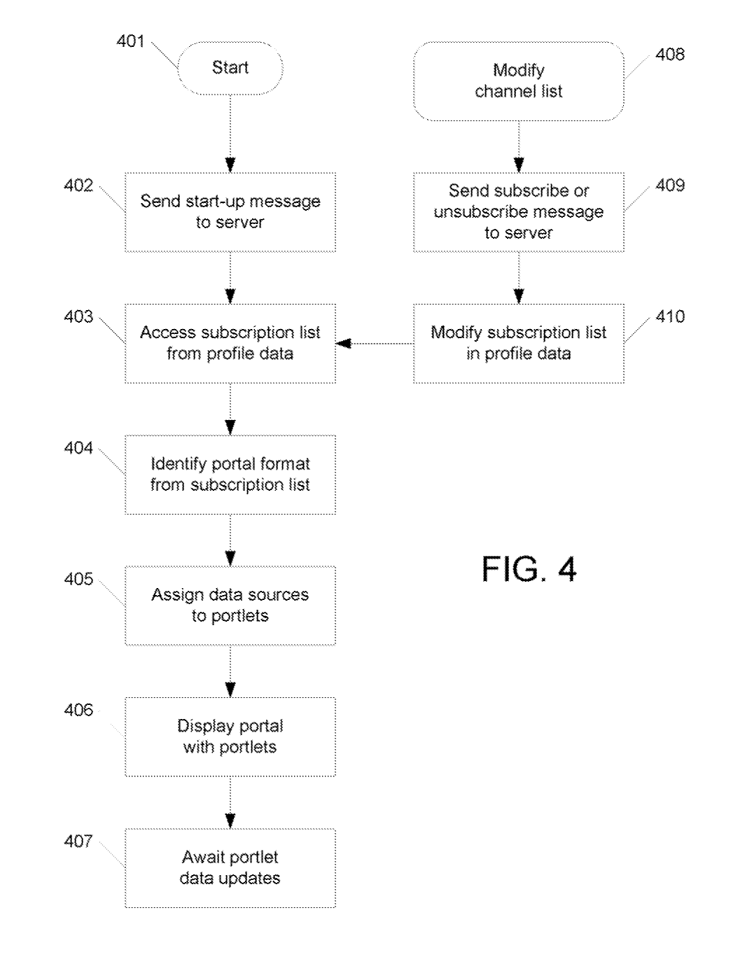

The processing carried out by the portal handler 205 when starting up and modifying a portal will now be described with reference to the flow chart of FIG. 4. At step 401, the portal client application 107 starts up and processing moves to step 402. At step 402, a start-up notification message is sent to the portal application program 106 and processing moves to step 403. At step 403, the portal client application accesses its client profile data 208 stored on the server and processing moves to step 404. At step 404, the portal handler 205 inspects the subscription data to identify the type and number of data sources to be provided via the portal and selects a suitable format for the portal from the portal layouts 207.

Processing then moves to step 405 where each data source is assigned to an appropriate portlet within the portal and the associations recorded in the preferences 206. Processing then moves to step 406 where the selected portal format is displayed. Processing then moves to step 407 to await the receipt of the actual data from the data sources in order to populate each portlet. This data population process will be described in further detail below. If a user enters an Add or Delete command via the menu 303, then processing starts at step 408 by prompting the user to identify the data source to be added or deleted. Processing then moves to step 409 where the user's response is encapsulated in a subscribe or unsubscribe message to the portal, server application program 106 and processing moves to step 410. At step 410, the portal handler 205 amends the subscription data in the profile data 208 held on the server and processing continues from step 404 as described above with the revised subscription list.

At any point, an administrator or user or suitable application program may access the profile data 208 on the server and modify the subscription data it contains. Any such external or remote modifications are detected by the portal server application program 107 which sends a message to the affected portal client application program on the attribute name corresponding to that client's userid. This message prompts the portal handler to access its profile data 208 as described above with reference to step 403 of FIG. 4. Processing then continues through steps 404 to 407 as described above. Therefore, as a result of the remote or external modification of the profile data 208, the format or layout of the portal and its portlets are automatically and dynamically updated or provisioned.

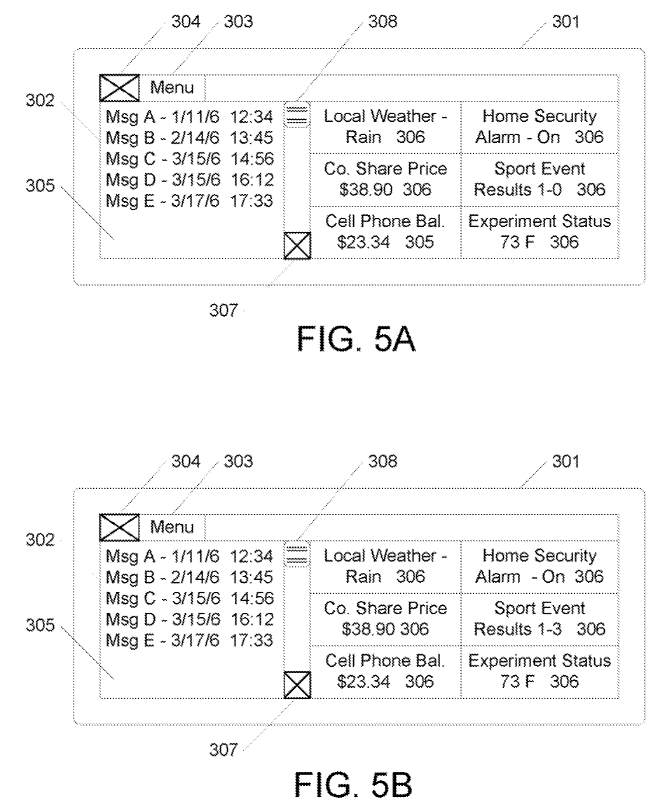

Once the portal server application 106 receives the startup message from the client the server sends an initial set of the subscribed data. Once received by the portal handler 205, the data is used to populate the portal page as shown in FIG. 5a. For example, the message providing the latest message (Msg E) would be as follows:

<msg>
<attribute>message account name 1</attribute>
<subject>Msg E</subject>
<body>Dear Sir, Please attend a meeting at 12pm tomorrow in room 134.
Admin</body>
</msg>

The message providing the data for the top left second portlet 306 (Local Weather) would be as follows:

<msg>
<attribute>Local Weather</attribute>
<subject>Local Weather - Rain</subject>
<body>Today's weather in New York will be heavy rain followed by
scattered showers.
Average temperature 50° F.</body>
</msg>

The portal handler 205 identifies the destination of the data contained in the messages by the message type, which is mapped by the preferences 206 to a given portal. Thus the first message above is displayed in the a portlet 505 as an addition to the list of messages already displayed, as shown in FIG. 5A, in accordance with the function of that portlet. The data from the second message is displayed in the top left second portlet 306 as shown in FIG. 5a. Similar messages provide the data for the remaining messages for the first portlet and to populate the remaining second portlets 306.

When new data is published by any of the subscribed data sources, the message processor 201 pushes update messages to the portal handier 205. For example, when a new message is published on the “message account 1” channel, the following message is sent to the portal handler 205:

<msg>
<type>message account name 1</type>
<subject>Msg F</subject>
<body>Dear Sir, Your car has been serviced and is ready for
collection.</body>
</msg>

Similarly, when a new message is published on the “Sport Event Results” channel, the following message is pushed to the portal handler 205:

<msg>
<type>Sport Event Results</type>
<subject>Sport Event Results - 1–3</subject>
<body>Team A have gone ahead scoring three goal in the last thee
minutes. Team B are struggling to regain their early control of the
game.</body>
</msg>

The portal handler 205 updates the relevant portlets 305, 306 accordingly as shown in FIG. 5b. While the message relating to the “message account 1” subscription has been added to the list of message in the first portlet 305, the data in the middle right second portlet 306 has been replaced with the new data in accordance with their defined portal and portlet layouts. As noted above, the details or body of the messages in the portlets 305, 306 can be viewed via the Show option in the menu 303.

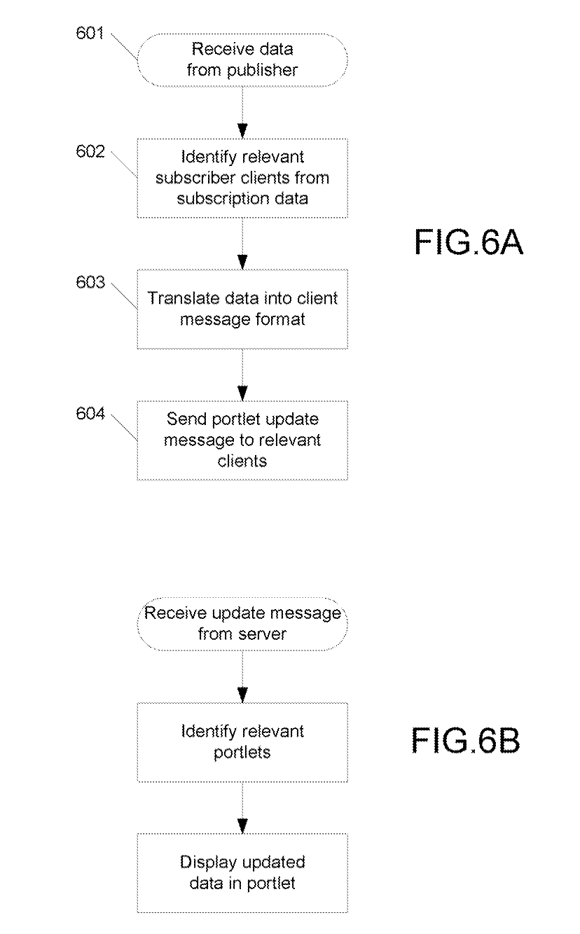

An overview of the processing carried out by the message processor 201 in handling published data will now be described with reference to the flowchart of FIG. 6A. At step 601, the message processor 201 receives data published on one of the data feeds 202 by one of the data sources and processing moves to step 602. At step 602, the subscribers to the newly published data are identified from the subscriptions data 204 and processing moves to step 603. At step 603, the published data is translated using the message transformation features of the WebSphere™ Message Broker into the format used by the portal client application 107 as described above. Processing then moves to step 604 where the message is sent to the subscribers' client devices 107.

The processing carried out by the portal handler 205 on receipt of a data message from the message processor 201 will now be described with reference to the flowchart of FIG. 6B. At step 605, the message is received and processing moves to step 606. At step 606 the portlets to which the message applies are identified from the message type and the preferences 206. Processing then moves to step 607 where the data from the message is displayed in the relevant portlets accordance with the defined portal layout. In other words, the data is either appended to the data already in the portlet or substituted for it.

In another embodiment, the message format enables actions to be carried by messages. These actions are identified by action tags in the message and rendered by the portal handler as buttons or menu items. These buttons or menu items allow a user to carry out actions from within a portlet. The tags associated with actions are as follows:
Actions—this is a top level tag for an action and can contain multiple actions.
Action—is the container tag for each action.
L—is a label as it appears in the button or menu.
T—this identifies the message attribute to publish back to, in other words, the destination or target for the action.
M—the data pay load for the destination or target.
$name, $time—these tags can be inserted into the message part, of the action and are substituted for the userid of the user and the timestamp when the action was clicked.

The following example shows a message, which informs a user that a light is on and includes an action, which will result in the light being turned off:

<msg>
<subj>Lamp</subj>
<body>Lamp is On </body>
<actions><action>
<l>Turn Off lamp</l>
<t>Hursley/lamp</t>
<m>0</m>
</action></actions>
</msg>

One use of actions could be to provide a mechanism for a user to subscribe to further data sources. For example, a user could subscribe to a list of data sources, perhaps provided by the message processor. The list is supplied to a portlet with subscribe or unsubscribe action buttons associated with each entry. The user can then use the buttons to add or delete subscriptions.

In a further embodiment, the message format allows for actions to have associated input fields that, for example, allow users to enter a specific response. Input fields work in conjunction with action buttons described above. The format for an input part of a message is as follows:

<inputs>
<input>Label</input>
</inputs>

Multiple inputs fields can be specified within a single message. The content of the input fields are ported into the payload of a return message using a substitution tag in the form $input<index> within an action message. In the example below, $input1 returns the content of a first input field into the payload of the Buy action:

<action>
<l>Buy<l>
<t>stock/IBM/buy</t>
<m>$input1</m>
</action>

In another embodiment, the actions provide three-way communications so that when an action is carried out by a user, further data is returned to the user in response by the data source.

In a further embodiment, a directory of data sources is compiled, with one or more entries including meta data. The portal client application is arranged to provide a search facility via a menu or specialized portlet to enable a user to enter a search term. The search term is then used to search the meta data in the directory to identify corresponding data sources of interest to the user. The search results can be returned to the user within a specialized portlet, which may enable the user to then subscribe to one or more of the data sources identified in the search results.

In another embodiment, a search is carried out on request or automatically using the users current set of subscriptions to identify similar data sources which are then provided to the user as a list of possible subscriptions. These suggested subscriptions may be presented as an information channel or added automatically to the profile data 208 resulting in dynamic reconfiguration of the portal and its portlets as described above with reference to FIG. 4.

In another embodiment, the profile data for all users is not held in one structure. Instead it is held for individual users in their own retained publication on a topic named UIB/channels/<userid>. The body of the message is a comma-delineated list. Thus each user effectively has their own profile data, instead of there being one large profile data store for all the users. In this way, access control features of the message processor can be used to control access to the profile data, which may be stored as one or more retained publications.

In a further embodiment, further message types are provided for enabling buddy lists, which identify which users on a predefined list of users are active. Other message types may be specialized for multimedia messages. The message type may be associated with one or more graphical icons for display in a portlet. Portlets displaying data of a given message type may be grouped and displayed together on a single page. The portal client application program may be arranged to store the icons and the XML messages may have an additional tag such as a “type” tag used to indicate which icon should be displayed.

In another embodiment, the client may be equipped with a layout manager, such as a JAVA™ based layout manager so that the layout of a portal and its portlets can be determined without recourse to a set of predefined layouts. In a further embodiment, the user is able to configure the portal layout manually. The user can order portlets within portal by time subscribed, alphanumerically or any other preferred order. In another embodiment, the last publication for a given channel is retained and when a client device starts up, the retained publications are provided to the client device.

As will be understood by those skilled in the art, the topic used within the publish/subscribe system may in turn be used to determine the message type and the data source between the server and client portal applications. The above embodiments may also be used in non-publish/subscribe data sources. As will be understood by those skilled in the art, the client device may be a computer or other programmable device and may be connected to the server by any suitable technique either wired or wireless. Furthermore, additional controls can be added to the user interface for the portal in addition to those described above. For example, “double clicking” can be used to display the detail of a selected portlet.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A method for managing a portal on a client device, the portal comprising one or more portlets for displaying data on the client device, the method steps being performed on the client device and comprising:
identifying a set of one or more data sources that are of interest to a user of the client device;
assigning each data source within said set to a respective portlet; and
in response to detecting a modification to the set of one or more data sources, adding or removing one or more respective portlets.

2. A method according to claim 1, further comprising the steps of:
receiving, via a portal server, display data from a first data source within said set of data sources; and
displaying the display data in the respective portlet assigned to the first data source.

3. A method according to claim 1 further comprising the steps of:
determining a first portal layout comprising an arrangement of one or more portlets for displaying data from said set of one or more data sources, the determining being based on the identified set of data sources; and
in response to the detection of a modification to the set of one or more data sources, determining a second portal layout comprising a second arrangement of one or more portlets for displaying data.

4. A method according to claim 1 comprising the further steps of:
receiving an add command, said add command identifying one or more data sources;
modifying the set of one or more data sources in response to said add command, to add one or more of the identified additional data sources; and
assigning a respective portlet to each added data source.

5. A method according to claim 4 comprising the further steps of:
receiving a delete command, said delete command identifying one or more data sources;
modifying the set of one or more data sources, in response to said delete command, to remove each data source that is the subject of said delete command.

6. A method according to claim 5 in which said identifying of a set of data sources is performed in response to data received at the client device via a portal server.

7. A method according to claim 6, wherein said add or delete commands are initiated from said client device.

8. A method according to claim 7 in which said set-up data is accessible so as to be remotely modifiable.

9. A portal manager for managing a portal in a client data processing device, said portal comprising one or more portlets for displaying data on the client device, said manager comprising:
set identifying logic for identifying a set of one or more data sources that are of interest to a user of the client device;
source assignment logic for assigning each data source within said set to a respective portlet; and
logic for, in response to detecting a modification to the set of one or more data sources, adding or removing one or more respective portlets.

10. Apparatus according to claim 9, wherein the client data processing device comprises, in addition to said portal manager:
a data processing unit;
a data storage unit;
a display screen; and
means for communicating with a portal server.

11. A portal system comprising:
a portal manager for managing a portal in a client data processing device, said portal comprising one or more portlets for displaying data on the client device, said manager comprising:
set identifying logic for identifying a set of one or more data sources that are of interest to a user of the client device,
source assignment logic for assigning each data source within said set to a respective portlet, and
logic for, in response to detecting a modification to the set of one or more data sources, adding or removing one or more respective portlets; and
a portal server operable to send, to the client data processing device, data relating to available data sources to enable the portal manager to identify said set of one or more data sources that are of interest to a user.

12. A portal system according to claim 11 in which display data is pushed from said portal server in response to updated display data being received by said portal server from a respective data source.

13. A portal system according to claim 12 in which said portal server is arranged to provide a list of available data sources to said client device to enable selection of data sources for said portal.

14. A computer program product comprising a machine usable medium embodying program instructions for managing a portal on a client device, said programs instructions when loaded onto and executed by a computer causing the computer to perform a method comprising the steps of:
identifying a set of one or more data sources that are of interest to a user of the client device;
assigning each data source within said set to a respective portlet; and
in response to detecting a modification to the set of one or more data sources, adding or removing one or more respective portlets.

15. A computer program product according to claim 14 further including program instructions for:
receiving, via a portal server, display data from a first data source within said set of data sources; and
displaying the display data in the respective portlet assigned to the first data source.

16. A computer program product according to claim 14 further comprising program instructions for:
determining a first portal layout comprising an arrangement of one or more portlets for displaying data from said set of one or more data sources, the determining being based on the identified set of data sources; and
in response to the detection of a modification to the set of one or more data sources, determining a second portal layout comprising a second arrangement of one or more portlets for displaying data.

17. A computer program product according to claim 16 further comprising program instructions for:
receiving an add command, said add command identifying one or more data sources;
modifying the set of one or more data sources in response to said add command, to add one or more of the identified additional data sources; and
assigning a respective portlet to each added data source.

18. A computer program product according to claim 17 further comprising program instructions for:
receiving a delete command, said delete command identifying one or more data sources;
modifying the set of one or more data sources, in response to said delete command, to remove each data source that is the subject of said delete command.

19. A computer program product according to claim 18 wherein the step of identifying of a set of data sources is performed in response to data received at the client device via a portal server.

20. A computer program product according to claim 19 wherein said add or delete commands are initiated from said client device.
